(19) United States
(12) Patent Application Publication
(10) Pub. No.: US 2008/0018803 A1
(43) Pub. Date: Jan. 24, 2008

(54) Fast Channel Change in Digital Video Broadcast Systems over Dsl Using Redundant Video Streams

(76) Inventors: Alexandros Michael Tourapis, Santa Clara, CA (US); Jill MacDonald Boyce, Manalapan, NJ (US)

Correspondence Address: THOMSON LICENSING LLC, Two Independence Way, Suite 200, PRINCETON, NJ, 08540, US

(21) Appl. No.: 11/631,449

(22) PCT Filed: Jun. 8, 2005
(86) PCT No.: PCT/US05/20029

§ 371 Date: Jan. 3, 2007

Related U.S. Application Data
(60) Provisional application No. 60/586,117, filed on Jul. 7, 2004.

(51) Int. Cl. H04N 5/50

(52) U.S. Cl. 348/731; 348/E05.097

(57) ABSTRACT

There are provided methods and apparatus for enabling a channel change in a Digital Subscriber Line (DSL) system. A channel change processing unit for enabling a channel change includes a selectore for receiving at least two video streams corresponding to a same program, and for selecting one of the at least two video streams for transmission based upon a position of intra-coded pictures in the at least two video streams.

### CROSS-REFERENCE TO RELATED APPLICATIONS

This application claims the benefit of U.S. Provisional Application Ser. No. 60/586,117, filed 7 Jul. 2004, which is incorporated by reference herein in its entirety.

### FIELD OF THE INVENTION

The present invention generally relates to Digital Subscriber Line (DSL) systems and, more particularly, to a method and apparatus for enabling a fast channel change in a DSL system using parallel streams.

### BACKGROUND OF THE INVENTION

In a commercial video over DSL broadcast system, it is desirable to allow end users to be able to change channels rapidly. Popular video compression standards, such as MPEG-2 and JVT/H.264/MPEG AVC use intra and inter coding. For proper decoding, a decoder must decode a compressed video sequence beginning with an intra-coded (I) picture, and then continue to decode the subsequent inter-coded (P and B) pictures. A Group of Pictures (GOP) may include an I picture and several subsequent P and B pictures. I pictures typically require many more bits to code than does a P or B picture of equivalent video quality, in the range of 3 to 10 times more bits. When a receiver initially begins receiving a program on a particular channel, following a channel change or initial turning on of the receiver, it must wait until an I picture is received to begin decoding properly, which causes a delay.

To minimize channel change delay in digital video broadcast systems, I pictures are typically sent frequently, for example every N pictures. For example, to enable a ½ second delay (of the video compression portion of the system), it is common to use N=15 for 30 frames per second (fps) content. Since compressed I pictures are so much larger than compressed P and B pictures, this considerably increases the bitrate over what would be required if I pictures were not inserted so frequently.

In some systems, instead of sending full I pictures frequently, a technique called “progressive refresh” is used, where sections of pictures are intra coded. Typically, all macroblocks in the picture are intra-coded at least once during an N-picture period. I pictures typically require significantly more bits to encode than P and B pictures.

In the JVT/H.264/MPEG AVC compression standard, P and B pictures may be predicted using multiple reference pictures, including the pictures before a preceding I picture. The standard identifies random access points as Independent Decoder Refreshes, or IDRs, which constrain that no reference pictures before the IDR are used in predicting pictures following the IDR. Pictures may be coded using slices of different types. A picture in which all coded slices are of type I may be referred to as an I picture.

The JVT/H.264/MPEG AVC compression standard includes a tool called redundant pictures, defined in the standard as follows:
redundant coded picture: A coded representation of a picture or a part of a picture. The content of a redundant coded picture shall not be used by the decoding process for a bitstream conforming to this Recommendation I International Standard. A redundant coded picture is not required to contain all macroblocks in the primary coded picture. Redundant coded pictures have no normative effect on the decoding process. See also primary coded picture.

The slice header contains a redundant_pic_cnt field, whose semantics are defined in the JVT/H.264/MPEG AVC compression standard as follows:
redundant_pic_cnt shall be equal to 0 for slices and slice data partitions belonging to the primary coded picture. The redundant_pic_cnt shall be greater than 0 for coded slices and coded slice data partitions in redundant coded pictures. When redundant_pic_cnt is not present, its value shall be inferred to be equal to 0. The value of redundant_pic_cnt shall be in the range of 0 to 127, inclusive.
   If the syntax elements of a slice data partition A RBSP indicate the presence of any syntax elements of category 3 in the slice data for a slice, a slice data partition B RBSP shall be present having the same value of slice_id and redundant_pic_cnt as in the slice data partition A RBSP.
   Otherwise (the syntax elements of a slice data partition A RBSP do not indicate the presence of any syntax elements of category 3 in the slice data for a slice), no slice data partition B RBSP shall be present having the same value of slice_id and redundant_pic_cnt as in the slice data partition A RBSP.

A system has been proposed wherein a channel change stream is encoded and transmitted along with the normal video bitstream. The channel change stream includes lower quality I pictures that are sent at a higher frequency than I pictures in the normal bitstream. When a user tunes to a new channel, playback could begin upon receipt of the first I pictures, in either the normal or channel change stream. This system is targeted at an end-to-end broadcast system, without any upstream indication of a channel change or possibility for storage at intermediate points in the system.

Another system has been proposed wherein a reduced resolution update codec is employed such that prediction residuals can be coded at lower resolutions for some of the coded pictures in a sequence, while other coded pictures in a sequence are coded at the full resolution. However, this system does not provide any capability for improved channel change efficiency.

Still another system has been proposed where a channel change stream is encoded and transmitted along with a normal bitstream over the regional broadband network. These streams may be stored at the DSLAM. When user channel change requests are received at the DSLAM, the channel change stream is sent over the DSL local loop for a short transition period, and then the normal stream is sent. If a channel change stream coded picture is larger than its corresponding normal stream coded picture, the instantaneous bandwidth requirements of the DSL local loop would be increased. This may cause problems with encoder rate control and buffer overflow/underflow at the decoder and the DSLAM. This problem can be avoided by limiting the size of the channel change stream coded pictures, which leads to lower quality video during a transitional period following a channel change.

### SUMMARY OF THE INVENTION

These and other drawbacks and disadvantages of the prior art are addressed by the present invention, which is directed to a method and apparatus for enabling a fast channel change in a Digital Subscriber Line (DSL) system using parallel streams.

According to an aspect of the present invention, in a Digital Subscriber Line Access Multiplexer (DSLAM) of a Digital Subscriber Line (DSL) system, there is provided a channel change processing unit for enabling a channel change. The channel change processing unit includes a selector for receiving at least two video streams corresponding to a same program, and for selecting one of the at least two video streams for transmission based upon a position of intra-coded pictures in the at least two video streams.

According to another aspect of the present invention, there is provided a video encoder for enabling a channel change in a Digital Subscriber Line (DSL) system. The video encoder includes an encoder for coding at least two video streams corresponding to a same program such that the at least two video streams include intra-coded pictures that occur at different positions in the at least two video streams.

According to still another aspect of the present invention, in a Digital Subscriber Line Access Multiplexer (DSLAM) of a Digital Subscriber Line (DSL) system, there is provided a method for enabling a channel change. The method includes the steps of receiving at least two video streams corresponding to a same program, and selecting one of the at least two video streams for transmission based upon a position of intra-coded pictures in the at least two video streams.

According to a further aspect of the present invention, there is provided an encoding method for enabling a channel change in a Digital Subscriber Line (DSL) system. The method includes the step of coding at least two video streams corresponding to a same program such that the at least two video streams include intra-coded pictures that occur at different positions in the at least two video streams.

These and other aspects, features and advantages of the present invention will become apparent from the following detailed description of exemplary embodiments, which is to be read in connection with the accompanying drawings.

### BRIEF DESCRIPTION OF THE DRAWINGS

The present invention may be better understood in accordance with the following exemplary figures, in which:

FIG. 1 shows a block diagram for an exemplary end-to-end architecture in accordance with the principles of the present invention;

FIG. 2A shows a diagram for exemplary picture coding patterns for two parallel video bitstreams in accordance with the principles of the present invention;

FIG. 2B shows a diagram for an exemplary picture coding pattern in accordance with the prior art;

FIG. 3 shows a diagram for exemplary picture coding order patterns in accordance with the principles of the present invention;

FIG. 4 shows a diagram for an exemplary method for enabling a channel change in a Digital Subscriber Line (DSL) system in accordance with the principles of the present invention.

### DETAILED DESCRIPTION OF PREFERRED EMBODIMENTS

The present invention is directed to a method and apparatus for enabling a fast channel change in a Digital Subscriber Line (DSL) system using parallel streams. The DSL local loop is the most bandwidth constrained link of an end-to-end video over DSL system. Advantageously, the present invention provides a method and apparatus for allowing low channel change delay while minimizing the DSL local loop bandwidth. Moreover, in accordance with the present invention, a desired channel change delay can be achieved without requiring I pictures to be sent over the DSL local loop as frequently as is done in prior art systems.

The present description illustrates the principles of the present invention. It will thus be appreciated that those skilled in the art will be able to devise various arrangements that, although not explicitly described or shown herein, embody the principles of the invention and are included within its spirit and scope.

All examples and conditional language recited herein are intended for pedagogical purposes to aid the reader in understanding the principles of the invention and the concepts contributed by the inventor to furthering the art, and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the invention. Similarly, it will be appreciated that any flow charts, flow diagrams, state transition diagrams, pseudocode, and the like represent various processes which may be substantially represented in computer readable media and so executed by a computer or processor, whether or not such computer or processor is explicitly shown.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means that can provide those functionalities as equivalent to those shown herein.

In accordance with the principles of the present invention, a desired channel change delay can be achieved without requiring I pictures to be sent over the DSL local loop as frequently as is done in prior art systems. Two or more parallel video bitstreams are created at the encoder, each of which contains I pictures that occur in the bitstream at different picture positions, with any desired spacing. The I-picture spacing for one of the parallel video streams is greater than the spacing of I-pictures of the combined bitstreams. Video decoding following a channel change can begin following any I-picture of the combined bitstreams. Only a single one of the parallel video bitstreams is sent over the DSL local loop at any time for a given program, so the DSL local loop bitrate requirement is reduced by allowing a larger I-picture spacing, while still allowing for quick channel change response.

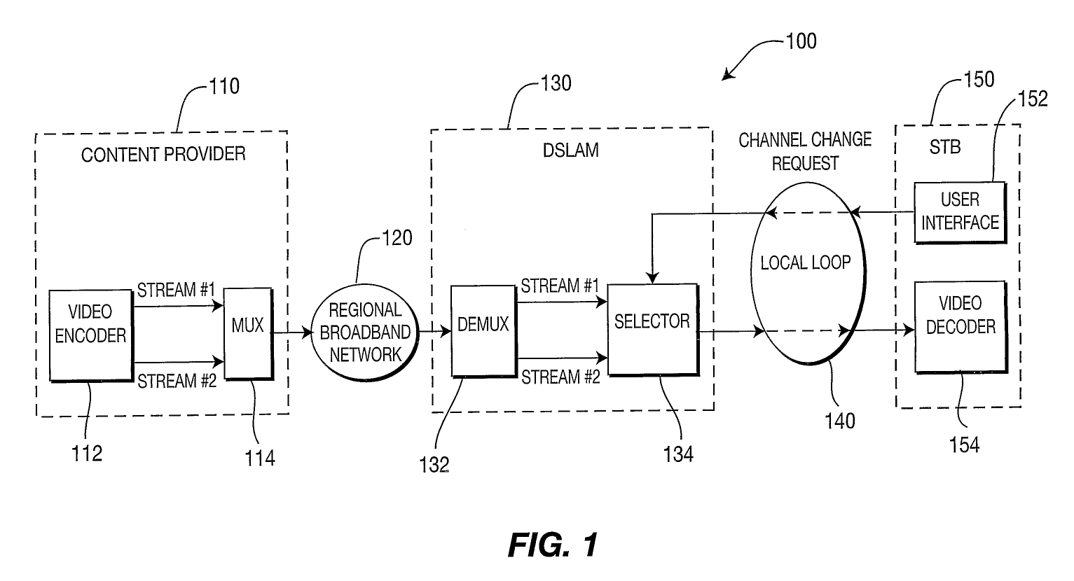

Turning to FIG. 1, an exemplary end-to-end architecture to which the present invention may be applied is indicated generally by the reference numeral 100. The exemplary end-to-end architecture 100 is directed to an example of the present invention that uses two parallel video bitstreams. However, it is to be appreciated that the present invention can be applied to any number of parallel video bitstreams. The architecture 100 includes a content provider 110, a regional broadband network 120, a digital subscriber line access multiplexer (DSLAM) 130, a local loop 140, and a set top box (STB) 150. The content provider 110 includes a video encoder 112 having a first and a second output in signal communication with a first and second input, respectively, of a multiplexer 114. An output of the multiplexer 1 -14 provides an output of the content provider 110, which is connected in signal communication with the regional broadband network 120. The regional broadband network 120 is further connected in signal communication with a first input of the DSLAM 130.

The DSLAM 130 includes a demultiplexer 132 having a first and a second output in signal communication with a first and second input, respectively, of a selector 134. The first input of the DSLAM 130 is connected in signal communication with an input of the demultiplexer 132, a second input of the DSLAM 130 is connected in signal communication with a third input of the selector 134, and an output of the DSLAM 130 is connected in signal communication with an output of the selector 134. The third input and the output of the DSLAM 130 are connected in signal communication with the local loop 140. It is to be appreciated that the DSLAM 130 is also interchangeably referred to herein as a “channel change processing unit”.

The STB 150 includes a user interface 152 and a video decoder 154. An output of the STB 150 is connected in signal communication with the local loop 140 and with the user interface 152, and an input of the STB 150 is connected in signal communication with the local loop 140 and with the video decoder 154.

The video encoder 112 creates two parallel video bitstreams. The two parallel video bitstreams are multiplexed together and transmitted over the regional broadband network 120 to a DSL Access Multiplexer (DSLAM) 130. For the sake of simplicity, only a single program's encoder is shown in FIG. 1. However, it is to be appreciated that in an actual system, multiple programs are supported and the elements of FIG. 1 may be duplicated for each supported program. A user makes a channel change request through the user interface 152 in the STB 150, to indicate a switch to a new program to be viewed. This request is forwarded to the DSLAM 130.

When playback of a particular program is requested by a user, either because of a channel change or initial turning on of the STB 150, a request is sent to the DSLAM 130 through the local loop 140. The DSLAM 130 then selects one of the parallel video bitstreams to send over the DSL local loop 140 to the STB 150.

Bandwidth requirements over the regional broadband network 120 are increased in accordance with this invention, because two or more parallel video bitstreams are transmitted for each program. Bandwidth requirements over the DSL local loop 140 are reduced, because fewer I pictures are transmitted over the DSL local loop 140. I pictures typically require significantly more bits than P and B pictures of the same image quality.

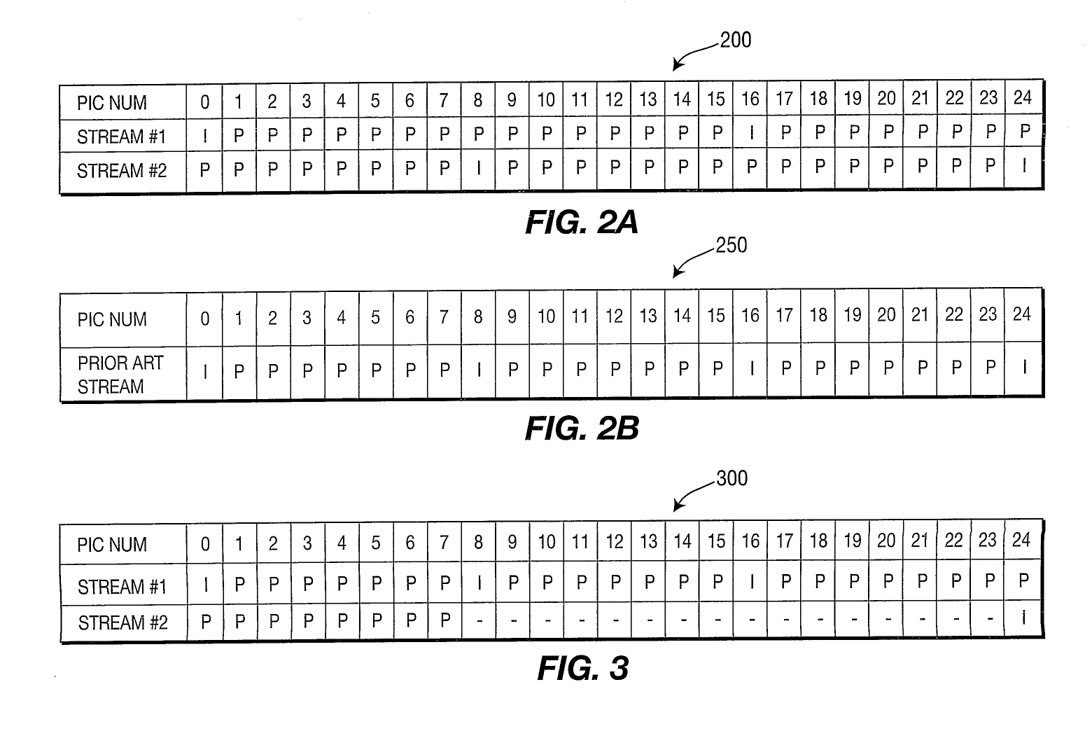

Turning to FIG. 2A, exemplary picture coding patterns for two parallel video bitstreams are indicated generally by the reference numeral 200. Turning to FIG. 2B, an exemplary picture coding pattern for a prior art system is indicated generally by the reference numeral 250. It is to be appreciated that the exemplary picture coding pattern 250 for the prior art system shown in FIG. 2B would have the same channel change delay as the exemplary picture coding patterns shown in FIG. 2A. In accordance with the present invention, both stream #1 and stream #2 would be transmitted over the regional broadband network 120. Only one of stream #1 or stream #2 would be transmitted over the DSL local loop 140, as selected by the DSLAM 130. The bitrate of stream #1 alone or stream #2 alone will be of lower bitrate for the same quality as the prior art stream, because the prior art stream includes twice as many I pictures as either stream #1 or stream #2. For every I picture in the prior art stream, either stream #1 or stream #2 includes an I picture at the same position.

It is to be appreciated that FIG. 2A represents a particular example and, thus, other picture coding patterns and numbers of parallel video bitstreams may be used while maintaining the spirit of the present invention. It is possible, for example, that an I picture be present in more than one of the parallel streams at the same position, particularly if that is advantageous for coding efficiency, e.g., at a scene change. The key requirement for the encoder 112 is that an I picture be present in at least one of the parallel streams within a pre-determined interval.

Each of the parallel video streams can be encoded to obey any desired rate control and buffer model. It is expected that each of the parallel video streams representing the same program be encoded to obey the same rate control and buffer model. When the DSLAM 130 receives a request to begin transmitting a particular program, it will select one of the parallel video streams to send to the STB 150. The DSLAM 130 will continue to send the selected stream to the STB 150 until the program is to cease being displayed, e.g., the STB 150 is turned off, or the channel is changed to a different program. No specific support is required at the STB 150 to support this feature, and the video quality is consistent after a channel change. There will be an initial delay in presentation of the video representing the newly requested channel, but after that initial delay is passed, smooth playback at the STB 150 can be achieved with the transmission of the bitstream from the DSLAM 130 to the STB 150 over the DSL local loop 140 at the average bitrate. This differs from the above-described system that may store a channel change stream at a DSLAM, which can be used with either full quality or lower quality channel change stream pictures. In that above-described system, when full quality channel change pictures are used, a higher instantaneous bandwidth over the local loop is required for smooth playback. In that above-described system, when lower quality channel change pictures are used, the video quality is temporarily reduced upon video playback. In the present invention, neither higher instantaneous bandwidth over the DSL local loop 140 or temporarily reduced video quality is necessary. However, in this invention, the bandwidth requirement over the regional broadband network 120 is increased.

One exemplary method that the DSLAM 130 could use to select which of the parallel video streams to send would be to monitor the incoming packets from each of the streams until an I picture is present in one of the streams. Then, the DSLAM 130 could select that stream that includes the I picture to send to the STB 150, and continue to send that selected stream. Fields in the packet header could be set to indicate that the packet contains an I picture, in order to simplify the operations needed at the DSLAM 130 to identify when an I picture has arrived in a particular stream. Alternatively, the location of I pictures in the parallel streams can be transmitted using some other means, such as user data fields, or can follow a fixed required pattern. If more than one of the parallel streams includes an I picture at the same picture position, any of those streams can be selected for transmission.

The bandwidth requirement over the regional broadband network 120 can be reduced in some cases, using an optional embodiment of the present invention. Turning to FIG. 3, exemplary picture coding order patterns for an optional embodiment of the present invention is indicated generally by the reference numeral 300. When a scene change occurs in a video sequence, it is typically more coding efficient to code the scene change picture as an I picture rather than as a P picture. If an I picture is coded in stream #1 ahead of schedule, e.g., because a scene change occurs, it is not necessary to also send an I picture and subsequent pictures in stream #2. In that case, no coded pictures need be transmitted for stream #2 for a period following the scene change I picture, while still maintaining the desired channel change interval at the STB 150. The stream selector at the DSLAM 130 will now sometimes have to switch from stream #2 to stream #1 even if a channel change has not occurred, if this embodiment is used. Side information can be sent, perhaps as user data, indicating the presence or absence of coded pictures in the parallel video streams to simplify the operation of the selector 134 at the DSLAM 130. Alternatively, the DSLAM 130 could determine for itself that a coded picture was present for a given display time in stream #1 without there being a corresponding coded picture in stream #2.

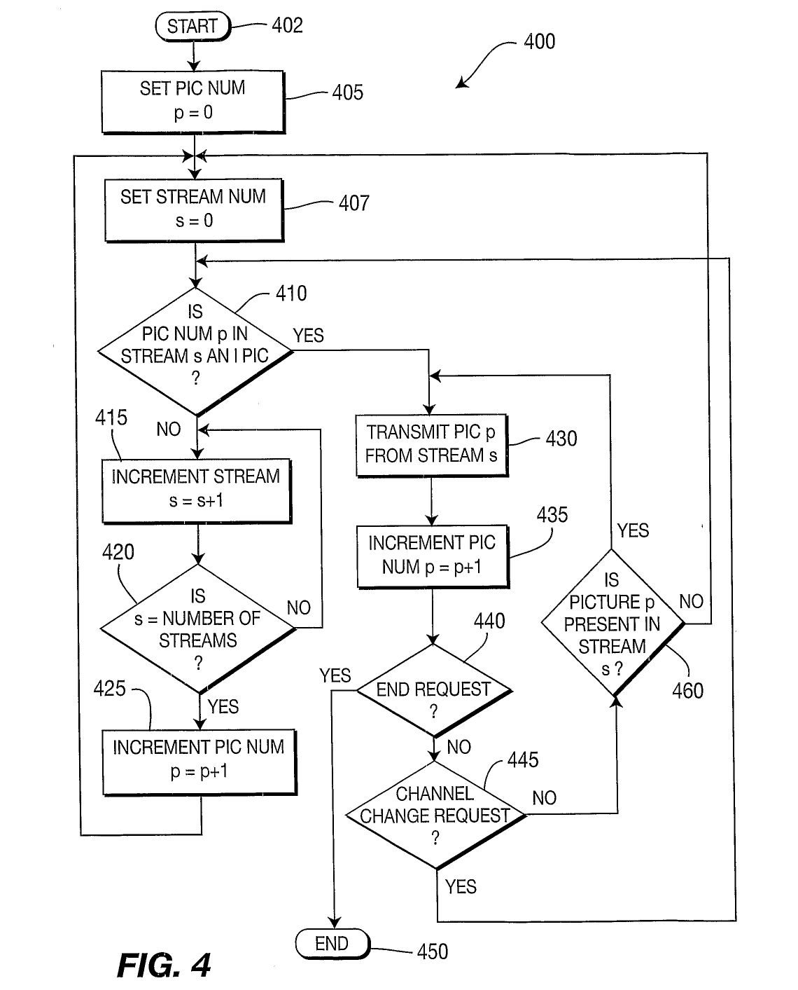

Turning to FIG. 4, an exemplary method for enabling a channel change in a Digital Subscriber Line (DSL) system is indicated generally by the reference numeral 400. A start block 402 passes control to a function block 405. The function block 405 sets the picture number p=0, and passes control to a function block 407. The function block 407 sets the stream number s=0, and passes control to a decision block 410. The decision block 410 determines whether or not picture number p in stream number s is an I (intra-coded) picture. If picture number p in stream number s is not an I picture, then control is passed to a function block 415. Otherwise, if picture number p in stream number s is an I picture, then control is passed to a function block 430. At function block 415, the stream number s is incremented by 1 (i.e., s=s+1), and control is passed to a decision block 420. The decision block 420 determines whether or not s =the (total) number of streams. If s does not equal the number of streams, then control is passed back to function block 415. Otherwise, if s=the number of streams, then control is passed to a function block 425. The function block 425 increments the picture number p by 1 (i.e., p=p+1), and passes control back to function block 407. At function block 430, picture p from stream s is transmitted, and control is passed to a function block 435. The function block 435 increments the picture number p by 1 (i.e., p=p+1), and passes control to a decision block 440. The decision block 440 determines whether or not an “end request” has been received (e.g., the user has turned off the set top box 150). If the end request has not been received, then control is passed to a decision block 445. Otherwise, if the end request has been received, then control is passed to an end block 450. At decision block 445, it is determined whether or not a channel change request has been received. If the channel change request has been received, then control is passed back to decision block 410. Otherwise, if the channel change request has not been received, then control is passed to a decision block 460. The decision block 460 determines whether or not picture p is present in stream s. If picture p is present in stream s, then control is passed back to function block 430. Otherwise, if picture p is not present in stream s, then control is passed back to function block 407.

A description will now be given of some of the many attendant advantages/features of the present invention. For example, one advantage/feature is a channel change processing unit at the DSLAM which receives two or more video streams corresponding to the same program, and selects one of the streams to transmit based upon the position of intra-coded pictures in the streams. Another advantage/feature is the channel change processing unit as described above, wherein the presence of intra-coded pictures is determined by a field in the packet header. Moreover, another advantage/feature is the channel change processing unit as described above, wherein the location of intra-coded pictures follows a pre-determined pattern. Still another advantage/feature is a video encoder that creates two or more video bitstreams representing the same program, which include intra-coded pictures occurring at different positions in the separate video bitstreams. Also, another advantage/feature is the encoder as described above, wherein the maximum interval between intra-coded pictures of the combined video bitstreams is limited based on desired channel change acquisition time.

These and other features and advantages of the present invention may be readily ascertained by one of ordinary skill in the pertinent art based on the teachings herein. It is to be understood that the teachings of the present invention may be implemented in various forms of hardware, software, firmware, special purpose processors, or combinations thereof.

Most preferably, the teachings of the present invention are implemented as a combination of hardware and software. Moreover, the software is preferably implemented as an application program tangibly embodied on a program storage unit. The application program may be uploaded to, and executed by, a machine comprising any suitable architecture. Preferably, the machine is implemented on a computer platform having hardware such as one or more central processing units (“CPU”), a random access memory (“RAM”), and input/output (“I/O”) interfaces. The computer platform may also include an operating system and microinstruction code. The various processes and functions described herein may be either part of the microinstruction code or part of the application program, or any combination thereof, which may be executed by a CPU. In addition, various other peripheral units may be connected to the computer platform such as an additional data storage unit and a printing unit.

It is to be further understood that, because some of the constituent system components and methods depicted in the accompanying drawings are preferably implemented in software, the actual connections between the system components or the process function blocks may differ depending upon the manner in which the present invention is programmed. Given the teachings herein, one of ordinary skill in the pertinent art will be able to contemplate these and similar implementations or configurations of the present invention.

Although the illustrative embodiments have been described herein with reference to the accompanying drawings, it is to be understood that the present invention is not limited to those precise embodiments, and that various changes and modifications may be effected therein by one of ordinary skill in the pertinent art without departing from the scope or spirit of the present invention. All such changes and modifications are intended to be included within the scope of the present invention as set forth in the appended claims.

1. A channel change processing unit for enabling a channel change comprising a selector for receiving at least two video streams corresponding to a same program and for selecting one of the at least two video streams for transmission based upon a position of intra-coded pictures in the at least two video streams.

2. The channel change processing unit as defined in claim 1, wherein said selector determines a presence of the intra-coded pictures using a field in a packet header of the at least two video streams.

3. The channel change processing unit as defined in claim 1, wherein a location of the intra-coded pictures in the at least two video streams follows a pre-determined pattern.

4. The channel change processing unit as defined in claim 1, wherein said selector is further for receiving channel change requests, and the one of the at least two video streams is selected for transmission in response to a receipt of a channel change request.

5. The channel change processing unit as defined in claim 1, wherein a scene change is coded in only one of the at least two video streams without the scene change being coded in other ones of the at least two video streams, and wherein said selector switches from any of the other ones of the at least two video streams to the only one of the at least two video streams based on a presence of the coded scene change in the only one of the at least two video streams, so that the only one of the at least two video streams is transmitted even in an absence of a channel change request.

6. A video encoder for enabling rapid channel change, the video encoder comprising an encoder for coding at least two video streams corresponding to a same program such that the at least two video streams include intra-coded pictures that occur at different positions in the at least two video streams.

7. The video encoder as defined in claim 6, wherein a maximum interval between the intra-coded pictures of a combination of the at least two video streams is limited based on a desired channel change acquisition time.

8. The video encoder as defined in claim 6, wherein said encoder respectively codes a field in a packet header of a packet of the at least two video streams, the field for indicating a presence of the intra-coded pictures.

9. The video encoder as defined in claim 6, wherein said encoder respectively codes the intra-coded pictures in the at least two video streams such the intra-coded pictures follow a pre-determined pattern.

10. The video encoder as defined in claim 6, wherein said encoder codes a scene change as an intra-coded picture in only one of the at least two video streams without the scene change being coded in other ones of the at least two video streams to reduce bandwidth consumption in a subsequent transmission of the at least two video streams.

11. A method for enabling a channel change, comprising the steps of:
receiving at least two video streams corresponding to a same program; and
selecting one of the at least two video streams for transmission based upon a position of intra-coded pictures in the at least two video streams.

12. The method as defined in claim 11, wherein said selecting step comprises the step of determining a presence of the intra-coded pictures using a field in a packet header of the at least two video streams.

13. The method as defined in claim 11, wherein a location of the intra-coded pictures in the at least two video streams follows a pre-determined pattern.

14. The method as defined in claim 11, further comprising the step of receiving a channel change request, and wherein the one of the at least two video streams is selected for transmission in response to a channel change request.

15. The method as defined in claim 11, wherein a scene change is coded in only one of the at least two video streams without the scene change being coded in other ones of the at least two video streams, and wherein the method further comprises the step of switching from any of the other ones of the at least two video streams to the only one of the at least two video streams based on a presence of the coded scene change in the only one of the at least two video streams, so that the only one of the at least two video streams is transmitted even in an absence of a channel change request.

16. An encoding method for enabling rapid channel change comprising the step of coding at least two video streams corresponding to a same program such that the at least two video streams include intra-coded pictures that occur at different positions in the at least two video streams.

17. The encoding method as defined in claim 16, wherein a maximum interval between the intra-coded pictures of a combination of the at least two video streams is limited based on a desired channel change acquisition time.

18. The encoding method as defined in claim 16, wherein said coding step respectively codes a field in a packet header of a packet of the at least two video streams, the field for indicating a presence of the intra-coded pictures.

19. The encoding method as defined in claim 16, wherein said coding step respectively codes the intra-coded pictures in the at least two video streams such the intra-coded pictures follow a pre-determined pattern.

20. The encoding method as defined in claim 16, wherein said coding step codes a scene change as an intra-coded picture in only one of the at least two video streams without the scene change being coded in other ones of the at least two video streams to reduce bandwidth consumption in a subsequent transmission of the at least two video streams.

21. A method for enabling a channel change, comprising the steps of:
generating at least two video streams corresponding to a same program; and
selecting one of the at least two video streams for transmission based upon a position of intra-coded pictures in the at least two video streams.
